(19) United States
(12) Patent Application Publication
(10) Pub. No.: US 2017/0141429 A1
(43) Pub. Date: May 18, 2017

(54) LITHIUM-ION CONDUCTING SOLID ELECTROLYTE, METHOD FOR MANUFACTURING THE SAME, AND LITHIUM BATTERY INCLUDING THE SAME

(71) Applicant: KOREA INSTITUTE OF ENERGY RESEARCH, Daejeon (KR)

(72) Inventors: Jong-won LEE, Daejeon (KR); Kyu-nam JUNG, Daejeon (KR); Rak-hyun SONG, Seoul (KR); Seok-joo PARK, Daejeon (KR); Seung-bok LEE, Daejeon (KR); Tak-hyoung LIM, Daejeon (KR); Sang-don LEE, Daejeon (KR)

(21) Appl. No.: 14/953,082

(22) Filed: Nov. 27, 2015

(30) Foreign Application Priority Data
Nov. 18, 2015 (KR) 10-2015-0161914

(51) Int. Cl. H01M 10/0562; H01M 10/052

(52) U.S. Cl. CPC H01M 10/0562; H01M 10/052; H01M 2300/0068

(57) ABSTRACT

According to an embodiment of the present disclosure, a solid electrolyte for a lithium battery comprises an oxide represented in the following chemical formula and a sintering aid including B₂O₃ or Bi₂O₃, wherein the chemical formula is L_{1+X}A_{X}B_{2-X}(PO₄)₃, wherein A is one or more substances selected from the group consisting of aluminum (Al), chrome (Cr), gallium (Ga), iron (Fe), scandium (Sc), indium (In), ruthenium (Ru), yttrium (Y), and lanthanum (La), B is one or more substances selected from the group consisting of titanium (Ti), germanium (Ge), and zirconium (Zr), and X has a value from 0.1 to 0.5.

### CROSS-REFERENCE TO RELATED APPLICATIONS

This patent application claims priority under 35 U.S.C. §119 to Korean Patent Application No. 10-2015-0161914, filed on Nov. 18, 2015, in the Korean Intellectual Property Office, the disclosure of which is incorporated by reference herein in its entirety.

### DISCUSSION OF RELATED ART

Vigorous research efforts are underway to use lithium batteries as power sources for electric automobiles, electronic devices, or other various applications.

Commercialized lithium ion batteries come in two different types: ones adopting organic liquid electrolytes and the others adopting inorganic solid electrolytes. Organic liquid electrolyte lithium ion batteries may suffer from explosion and electrolyte leakage.

Inorganic solid electrolytes may include sulfide-based or oxide-based substances. Lithium batteries, upon adopting sulfide-based substances as their electrolytes, may create toxic gases, e.g., H₂S.

Lithium batteries using oxide-based solid electrolytes may present increased ionic conductance without creating hazardous gases. However, such conventional solid electrolyte-based lithium batteries have a reduced grain boundary resistance and to reduce the resistance require a sintering process at a higher temperature.

### SUMMARY

According to an embodiment of the present disclosure, a solid electrolyte for a lithium battery comprises an oxide represented in the following chemical formula and a sintering aid including B₂O₃ or Bi₂O₃, wherein the chemical formula is Li_{1+X}A_{X}B_{2-X}(PO₄)₃. Here A is one or more substances selected from the group consisting of aluminum (Al), chrome (Cr), gallium (Ga), iron (Fe), scandium (Sc), indium (In), ruthenium (Ru), yttrium (Y), and lanthanum (La), B is one or more substances selected from the group consisting of titanium (Ti), germanium (Ge), and zirconium (Zr), and X has a value from 0.1 to 0.5.

The content of the sintering aid may be 0.1 to 3.0 parts by weight relative to 100 parts by weight of the solid electrolyte.

The solid electrolyte may further include a substance selected from the group consisting of LLZO (Li₇La₃ZrO₁₂), LLTO (Li₃ₓLa_{2/3-x}TiO₃, 0<x<⅔), and LiPON (Li_{3-y}PO₄₋ₓNₓ, 0<y<3, 0<x<4).

An ionic conductance of the solid electrolyte may be not less than a value from 5.0×10⁻⁵ S/cm to 3.0×10⁻³ S/cm.

According to an embodiment of the present disclosure, a method for preparing a solid electrolyte comprises reacting a chelating agent with a first metal precursor including a Li precursor, a second metal precursor including a precursor of a metal selected from the group consisting of Al, Cr, Ga, Fe, Sc, In, Ru, Y, and La, a third metal precursor including a precursor of a metal selected from the group consisting of Ti, Ge, and Zr, and a P precursor to form a sol, forming a gel by heating the sol, pyrolizing the gel, thermal-treating the pyrolized gel while bringing the gel in contact with the air to form a powder, cooling the powder, mixing the cooled powder with a sintering aid, and press-forming the mixed powder and sintering the mixed powder while bringing the mixed powder in contact with the air.

The Li precursor may include one or more substances selected from the group consisting of LiNO₃, Li₂CO₃, Li₂SO₄, and LiCl.

The Al precursor may include one or more substances selected from the group consisting of a nitrogen compound, a sulfur compound, and a chlorine compound.

The Ti precursor may include one or more substances selected from the group consisting of Ti(OCH₂CH₂CH₂CH₃)₄, and Ti[OCH(CH₃)₂]₄.

The Ge precursor may include one or more substances selected from the group consisting of germanium dioxide (GeO₂), germanium tetrachloride (GeCl₄), germanium ethoxide (Ge(OC₂H₅)₄), germanium isopropoxide (Ge[OCH(CH₃)₂]₄), and germanium methoxide (Ge(OCH₃)₄).

The Zr precursor may include one or more substances selected from the group consisting of zirconium oxide (ZrO₂), zirconium chloride (ZrCl₄), zirconium oxynitrate (ZrO(NO₃)₂), zirconium propoxide (ZrO(CH₂CH₂CH₃)₄), zirconium butoxide (Zr(OC₄H₉)₄), zirconium isopropoxide (Zr[OCH(CH₃)₂]₄), and zirconium tert-butoxide (Zr[OC(CH₃)₃]₄).

The P precursor may include one or more substances selected from the group consisting of NH₄H₂PO₄, and H₃PO₄.

The chelating agent may include citric acid or acetic acid.

The amount of the chelating agent may correspond to about two to six times a sum of mole numbers of the first metal precursor, the second metal precursor, the third metal precursor, and the P precursor.

The sol may be heated at about 120° C. to about 200° C.

The gel may be heated at about 250° C. to about 350° C.

The pyrolized gel may be heated at about 700° C. to about 850° C.

The amount of the sintering aid may be about 0.1 weight % to about 3.0 weight %/o relative to the total amount of the powder and the sintering aid.

The sintering aid may include one or more substances selected from the group consisting of B₂O₃ or Bi₂O₃.

When the sintering aid is B₂O₃, the sintering temperature may be about 750° C. to about 1000° C., and when the sintering aid is Bi₂O₃, the sintering temperature may be about 750° C. to about 850° C.

According to an embodiment of the present disclosure, a lithium battery comprises a cathode including a cathode active material, an anode including an anode active material, a separator, an electrolyte solution, and a solid electrolyte. The solid electrolyte may comprise an oxide represented in the following chemical formula and a sintering aid including B₂O₃ or Bi₂O₃, wherein the chemical formula is Li_{1+X}A_{X}B_{2-X}(PO₄)₃. Here A is one or more substances selected from the group consisting of aluminum (Al), chrome (Cr), gallium (Ga), iron (Fe), scandium (Sc), indium (In), ruthenium (Ru), yttrium (Y), and lanthanum (La), B is one or more substances selected from the group consisting of titanium (Ti), germanium (Ge), and zirconium (Zr), and X has a value from 0.1 to 0.5. The content of the sintering aid may be 0.1 to 3.0 parts by weight relative to 100 parts by weight of the solid electrolyte. The solid electrolyte may further include a substance selected from the group consisting of LLZO (Li₇La₃Zr₂O₁₂), LLTO (Li₃ₓLa_{2/3-x}TiO₃, 0<x<⅔), and LiPON (Li_{3-y}PO₄₋ₓNₓ, 0<y<3, 0<x<4). An ionic conductance of the solid electrolyte may be not less than a value from 5.0×10⁻⁵ S/cm to 3.0×10⁻³ S/cm.

The cathode active material may include one or more substances selected from the group consisting of LiCoO₂, LiMnO₂, LiMn₂O₄, LiNi₁₋ₓMnₓO₂ (0<x<1), LiNi_{1-x-y}CoₓMn_{y}O₂ (0<x<0.5, 0<y<0.5), LiFePO₄, TiS₂, and FeS₂.

The anode active material may include one or more substances selected from the group consisting of lithium, a lithium-alloyable metal including one or more substances selected from the group consisting of Si, Sn, Al, Ge, Pb, and Bi, a metal oxide including one or more substances selected from the group consisting of lithium-titan oxide, SnO₂, and SiOₓ (0<x<2), and one or more substances selected from the group consisting of carbon-based substances including crystalline carbon, amorphous carbon, or a combination thereof.

The cathode, the anode, and the solid electrolyte may be separated by the separator.

The separator may be selected from the group consisting of glass fiber, polyester, Teflon, polyethylene, polypropylene, and polytetrafluoroethylene (PTFE).

The electrolyte solution may include a solvent and a lithium salt dissolved in the solvent, wherein the solvent includes the solvent includes propylene carbonate, ethylene carbonate, fluoro-ethylene carbonate, diethyl carbonate, ethylmethyl carbonate, methylpropyl carbonate, butylene carbonate, benzonitrile, acetonitrile, tetrahydrofuran, 2-methyl tetrahydrofuran, γ-butyrolactone, dioxolane, 4-methyl-dioxolane, N, N-dimethylformamide, dimethylacetamide, dimethyl sulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, dibutyl carbonate, diethylene glycol, dimethyl ether, dimethyl glycol, dimethyl trimethyl glycol, dimethyl tetra-glycol, or a combination thereof, and the lithium salt includes LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein, x and y are natural numbers), LiCl, LiI, or a combination thereof.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating X-ray diffraction patterns of solid electrolyte sintered bodies respectively produced according to first, second, third, and fourth embodiments of the present disclosure;

FIG. 2 is a view illustrating X-ray diffraction patterns of solid electrolyte sintered bodies respectively produced according to seventh, eighth, ninth, and tenth embodiments of the present disclosure;

FIG. 3 is a view illustrating the respective cross sections of solid electrolyte sintered bodies produced according to the first to tenth embodiments of the present disclosure, which are obtained by experiments using a scanning electron microscope (SEM); and

FIG. 4 is a view illustrating the respective impedance spectra of solid electrolyte sintered bodies produced according to the first to fourth embodiments of the present disclosure.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise.

Embodiments of the present disclosure concern increasing the ionic conductance of a solid electrolyte for a lithium battery and reducing the sintering temperature through a sintering agent in preparing the solid electrolyte.

According to an embodiment of the present disclosure, a solid electrolyte for a lithium battery may include an oxide represented in the following chemical formula: Li_{1+X}A_{X}B_{2-X}(PO₄)₃, and a sintering aid including B₂O₃ or Bi₂O₃. The oxide may have a NASICON structure. In the above chemical formula, A may include one or more substances selected from the group consisting of aluminum (Al), chrome (Cr), gallium (Ga), iron (Fe), scandium (Sc), indium (In), ruthenium (Ru), yttrium (Y), and lanthanum (La), B may include one or more substances selected from the group consisting of titanium (Ti), germanium (Ge), and zirconium (Zr), and X may have a value from 0.1 to 0.5.

According to an embodiment of the present disclosure, the content of the sintering aid may be about 0.1 parts by weight to about 3.0 parts by weight relative to 100 parts by weight of the solid electrolyte. When the content of the sintering aid is not more than 0.1 parts by weight relative to the 100 parts by weight of the solid electrolyte, the sintering aid might not be sufficiently distributed on grain boundaries of the solid electrolyte to fail to play a role as a sintering agent. When the content of the sintering aid is not less than 3.0 parts by weight relative to the 100 parts by weight of the solid electrolyte, the sintering aid may react with the solid electrolyte particles to produce a second phase or other impurities or to change the composition of the solid electrolyte to result in the ionic conductance of the solid electrolyte decreasing.

According to an embodiment of the present disclosure, the solid electrolyte may further include a normal solid electrolyte subject to a sintering process. For example, the solid electrolyte may include LLZO (Li₇La₃Zr₂O₂) having an oxide-based garnet structure, LiPON (Li_{3-y}PO₄₋ₓNₓ, 0<y<3, 0<x<4) or LLTO (Li₃ₓLa_{2/3-x}TiO₃, 0<x<⅔) having a perovskite structure. However, embodiments of the present disclosure are not limited thereto, and any other substances may also be used.

According to an embodiment of the present disclosure, the ionic conductance of the solid electrolyte may be not less than a value from 5.0×10⁻⁵ S/cm to 3.0×10⁻³ S/cm.

According to an embodiment of the present disclosure, a method for preparing a solid electrolyte includes reacting a chelating agent with a first metal precursor including a Li precursor, a second metal precursor including a precursor of a metal selected from the group consisting of Al, Cr, Ga, Fe, Sc, In, Ru, Y, and La, a third metal precursor including a precursor of a metal selected from the group consisting of Ti, Ge, and Zr, and, a P precursor to form a sol, forming a gel by heating the sol, pyrolizing the gel, thermal-treating the pyrolized gel while bringing the gel in contact with the air to form a powder, cooling the powder, mixing the cooled powder with a sintering aid, and press-forming the mixed powder and sintering the mixed powder while bringing the mixed powder in contact with the air.

According to an embodiment of the present disclosure, as the first metal precursor, e.g., the Li precursor may include one or more substances selected from the group consisting of LiNO₃, Li₂CO₃, Li₂SO₄, and LiCl.

According to an embodiment of the present disclosure, as the second metal precursor, e.g., the Al precursor may include one or more substances selected from the group consisting of a nitrogen compound, a sulfur compound, and a chlorine compound.

According to an embodiment of the present disclosure, as the third metal precursor, e.g., the Ti precursor may include one or more substances selected from the group consisting of Ti(OCH₂CH₂CH₂CH₃)₄, and Ti[OCH(CH₃)₂]₄.

According to an embodiment of the present disclosure, the Ge precursor may include one or more substances selected from the group consisting of germanium dioxide (GeO₂), germanium tetrachloride (GeCl₄), germanium ethoxide (Ge(OC₂H₅)₄), germanium isopropoxide (Ge[OCH(CH₃)₂]₄), and germanium methoxide (Ge(OCH₃)₄).

According to an embodiment of the present disclosure, the Zr precursor may include one or more substances selected from the group consisting of zirconium oxide (ZrO₂), zirconium chloride (ZrCl₄), zirconium oxynitrate (ZrO(NO₃)₂), zirconium propoxide (ZrO(CH₂CH₂CH₃)₄), zirconium butoxide (Zr(OC₄H₉)₄), zirconium isopropoxide (Zr[OCH(CH₃)₂]₄), and zirconium tert-butoxide (Zr[OC(CH₃)₃]₄).

According to an embodiment of the present disclosure, the P precursor may include one or more substances selected from the group consisting of NH₄H₂PO₄, and H₃PO₄.

According to an embodiment of the present disclosure, the first to third metal precursors may be dissolved in a solvent to prepare a solution, and the chelating agent may be added to the solution to thereby form the sol.

As the chelating agent, e.g., citric acid or acetic acid may be used. As the solvent, ethylene glycol, distilled water (D.I. water), ethanol (CH₃CH₂OH), or dimethyl Ether ((CH₃)₂O) may be used.

According to an embodiment of the present disclosure, the amount of the chelating agent added may be about two to six times a sum of mole numbers of the first, second, and third metal precursors and the P precursor.

The obtained sole may be heated to form the gel.

The sol may be heated at about 120° C. to about 200° C. When the heating temperature is not more than 120° C., the processing time for converting the sol to the gel may be increased, and impurities might not be removed in a sufficient quantity. When the heating temperature is not less than 200° C., the sol-to-gel change may occur too fast, rendering it difficult for the precursors to be distributed in a satisfactory degree.

The formed gel is subjected to thermal decomposition or pyrolysis.

For example, the gel may be heated at about 250° C. to about 350° C. When the heating temperature is not more than 250° C., remaining impurities and solvents might not be removed in a satisfactory quantity, and the processing time may take longer. When the heating temperature is not less than 350° C., the gel may be too quickly transformed to a solid product without distributed to a sufficient degree while leaving the resultant solid product to be porous.

The pyrolyzed gel is thermally treated while in contact with the air to obtain a powder.

For example, the temperature of the thermal treatment may be about 700° C. to about 850° C. When the thermal treatment proceeds at a temperature not more than 700° C., the solid electrolyte powder may be less crystalline to exhibit reduced ionic conductance. When the temperature of the thermal treatment is not less than 850° C., a phase shift may occur upon heating, rendering the resultant powder to have an increased particle size and resultantly deteriorated ionic conductance.

The obtained powder is cooled down.

The cooled powder is mixed with a sintering aid.

The sintering aid may include B₂O₃ or Bi₂O₃. The amount of the sintering aid added may be about 0.1 weight % to about 3.0 weight % relative to the total amount of the powder and the sintering aid. When the amount of the sintering aid is not more than 0.1 weight %, the sintering aid might not be sufficiently distributed on grain boundaries of the solid electrolyte and may thus fail to play a role as a sintering aid. When the amount of the sintering aid is not less than 3.0 weight %, too much of the sintering aid may react with the solid electrolyte particles, leaving a second phase or other impurities while changing the composition of the solid electrolyte. Thus, the ionic conductance of the solid electrolyte may be deteriorated.

The mixing process may be performed by, e.g., ball milling.

The obtained powder is press-formed and is sintered while brought in contact with the air.

For example, when the sintering aid is B₂O₃, the sintering temperature may be about 750° C. to about 1000° C., and when the sintering aid is Bi₂O₃, the sintering temperature may be about 750° C. to about 850° C. When the sintering temperature of B₂O₃ is not more than 750° C., B₂O₃ might not be melt down to a sufficient degree, rendering it difficult for B₂O₃ to evenly form on the final sintered boundaries. Accordingly, in this case, the sintering aid may play its role properly. When the sintering temperature of B₂O₃ is not less than 1000° C., B₂O₃ may be spread in the solid electrolyte particles upon heating, leading to changes in the composition or structure of the solid electrolyte and resultantly the ionic conductance of the solid electrolyte being deteriorated. Substantially the same issues may arise when Bi₂O₃ departs from the above sintering temperature range, e.g., from about 750° C. to about 1000° C.

By the above method, the obtained solid electrolyte may have an ionic conductance of about 5.0×10⁻⁵ S/cm to about 3.0×10⁻³ S/cm at about 25° C.

According to an embodiment of the present disclosure, a lithium battery may include a cathode including a cathode active material, an anode including an anode active material, and a solid electrolyte between the cathode and the anode. The solid electrolyte may reduce the interfacial resistance between the solid electrolyte and the cathode or between the solid electrolyte and the anode, thereby leading to a reduced cell resistance. A high-molecular (e.g., polymer) electrolyte layer may be disposed between the cathode and the solid electrolyte and/or between the anode and the solid electrolyte. The high-molecular electrolyte layer may increase chemical stability of the solid electrolyte while bringing the solid electrolyte in more tight contact with the cathode or the anode. The high-molecular electrolyte layer may be immersed in an organic electrolyte solution including a lithium salt and an organic solvent.

The cathode active material may include, but is not limited to, the cathode active material includes a lithium transition metal oxide or a transition metal sulfide, such as, e.g., LiCoO₂, LiMnO₂, LiMn₂O₄, LiNi₁₋ₓMnₓO₂ (0<x<1), LiNi_{1-x-y}CoₓMn_{y}O₂ (0<x<0.5, 0<y<0.5), LiFePO₄, TiS₂, or FeS₂. Alternatively, other materials typically used in a lithium battery may also be used as the cathode active material.

As the anode active material, any materials typically used in a lithium battery may be used. For example, the anode active material may include lithium, a lithium-alloyable metal, a metal oxide, or a carbon-based material. For example, the lithium-alloyable metal may include Si, Sn, Al, Ge, Pb, and Bi. The metal oxide may include lithium-titan oxide, SnO₂, and SiOₓ(0<x<2). The carbon-based substances may include crystalline carbon, amorphous carbon, or a combination thereof.

The cathode, the anode, and the solid electrolyte are separated by a separator. Any separator typically used in a lithium battery may be used. For example, a separator with a lower resistance to ions travelling in the electrolyte and that may be readily immersed in the electrolyte solution may be used. For example, the separator may include glass fiber, polyester, Teflon, polyethylene, polypropylene, or polytetrafluoroethylene (PTFE). For example, the separator may include woven or non-woven fabric formed of glass fiber, polyester, Teflon, polyethylene, polypropylene, or polytetrafluoroethylene (PTFE). For example, the separator may be a woundable separator formed of, e.g., polyethylene or polypropylene or a separator readily immersible in an organic electrolyte solution.

The electrolyte solution may include a solvent and a lithium salt dissolved in the solvent. The solvent may include the solvent includes propylene carbonate, ethylene carbonate, fluoro-ethylene carbonate, diethyl carbonate, ethylmethyl carbonate, methylpropyl carbonate, butylene carbonate, benzonitrile, acetonitrile, tetrahydrofuran, 2-methyl tetrahydrofuran, γ-butyrolactone, dioxolane, 4-methyl-dioxolane, N, N-dimethylformamide, dimethylacetamide, dimethyl sulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, dibutyl carbonate, diethylene glycol, dimethyl ether, dimethyl glycol, dimethyl trimethyl glycol, dimethyl tetra-glycol, or a combination thereof, and the lithium salt may include LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein, x and y are natural numbers), LiCl, LiI, or a combination thereof.

The lithium battery may be used for various purposes, including, e.g., electric vehicles, hybrid vehicles, and small electronic devices, such as cell phones or portable computers.

### First Embodiment

As starting materials, a Li precursor, e.g., LiNO₃, an Al precursor, e.g., Al(NO₃)₃.9H₂O, a Ti precursor, e.g., Ti(OCH₂CH₂CH₂CH₃)₄, and a P precursor, e.g., NH₄H₂PO₄, were chosen. To obtain Li_{1.4}Al_{0.4}Ti_{1.6}(PO₄)₃, a molar ratio of Li:Al:Ti:P was adjusted to 1.4:0.4:1.6:3. The starting materials were dissolved in ethylene glycol, and citric acid ((HOC(COOH)(CH₂COOH)₂)) was added to the solution to thus form a sol. The amount of citric acid added is about four times the total number of moles of the metal nitrates.

The solution was heated at 170° C. to form the gel. The gel was kept heated and was pyrolized at 300° C. The gel was thermally treated at 800° C. for five hours, thus obtaining a solid electrolyte powder.

0.5 wt % boron oxide (B₂O₃) was added to the thermally treated powder and was then ball-milled at 200 rpm for 24 hours.

The ball-milled powder was dried and mono-axial press-formed at 500 MPa into pellets. The pellets were sintered in a furnace at 200° C./h (heating rate) and 800° C. in the atmosphere of air for six hours and were then naturally dried to form a solid electrolyte sintered body.

### Second Embodiment

A solid electrolyte sintered body was obtained in substantially the same manner given in the first embodiment except that the sintering process was performed at 850° C.

### Third Embodiment

A solid electrolyte sintered body was obtained in substantially the same manner given in the first embodiment except that the sintering process was performed at 900° C.

### Fourth Embodiment

A solid electrolyte sintered body was obtained in substantially the same manner given in the first embodiment except that the sintering process was performed at 950° C.

### Fifth Embodiment

A solid electrolyte sintered body was obtained in substantially the same manner given in the first embodiment except that 0.2 wt % B₂O₃ was added to the thermally treated powder and the sintering process was performed at 850° C.

### Sixth Embodiment

A solid electrolyte sintered body was obtained in substantially the same manner given in the first embodiment except that 1 wt % B₂O₃ was added to the thermally treated powder and the sintering process was performed at 850° C.

### Seventh Embodiment

A solid electrolyte sintered body was obtained in substantially the same manner given in the first embodiment except that 0.5 wt % Bi₂O₃ was added to the thermally treated powder.

### Eighth Embodiment

A solid electrolyte sintered body was obtained in substantially the same manner given in the first embodiment except that 0.5 wt % Bi₂O₃ was added to the thermally treated powder and the sintering process was performed at 850° C.

### Ninth Embodiment

A solid electrolyte sintered body was obtained in substantially the same manner given in the first embodiment except that 0.5 wt % Bi₂O₃ was added to the thermally treated powder and the sintering process was performed at 900° C.

### Tenth Embodiment

A solid electrolyte sintered body was obtained in substantially the same manner given in the first embodiment except that 0.5 wt % Bi₂O₃ was added to the thermally treated powder and the sintering process was performed at 950° C.

### Eleventh Embodiment

A solid electrolyte sintered body was obtained in substantially the same manner given in the first embodiment except that 0.2 wt % Bi₂O₃ was added to the thermally treated powder and the sintering process was performed at 850° C.

### Twelfth Embodiment

A solid electrolyte sintered body was obtained in substantially the same manner given in the first embodiment except that 1 wt % Bi₂O₃ was added to the thermally treated powder and the sintering process was performed at 850° C.

### Comparison Example 1

A solid electrolyte sintered body was obtained in substantially the same manner given in the first embodiment except that no additive was added to the thermally treated powder.

### Comparison Example 2

A solid electrolyte sintered body was obtained in substantially the same manner given in the first embodiment except that no additive was added to the thermally treated powder and the sintering process was performed at 850° C.

### Comparison Example 3

A solid electrolyte sintered body was obtained in substantially the same manner given in the first embodiment except that no additive was added to the thermally treated powder and the sintering process was performed at 900° C.

### Comparison Example 4

A solid electrolyte sintered body was obtained in substantially the same manner given in the first embodiment except that no additive was added to the thermally treated powder and the sintering process was performed at 950° C.

### Assessment Example 1: X-Ray Diffraction Experiment

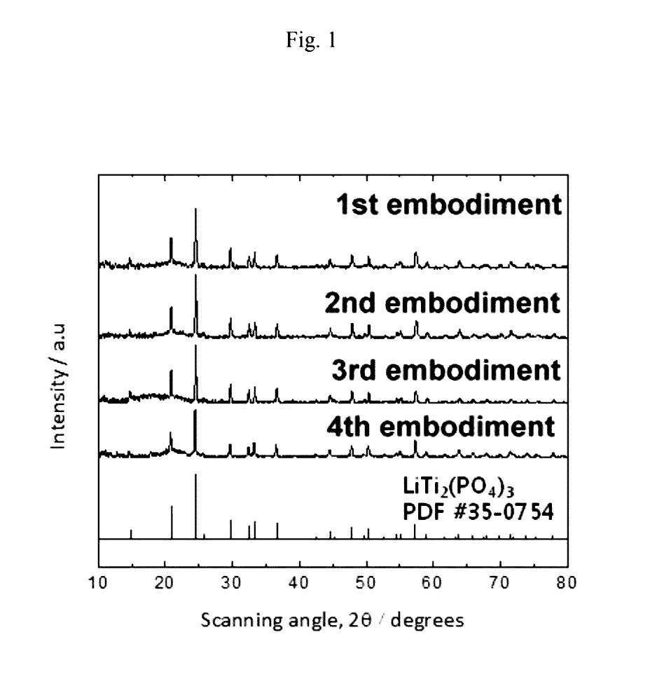

An X-ray diffraction experiment was conducted to grasp the crystalline structure of the solid electrolytes obtained according to the first to fourth embodiments of the present disclosure. A result of the test is shown in FIG. 1. As evident from FIG. 1, the solid electrolytes have substantially the same peak diffraction as LiTi₂(PO₄)₃ with a NAISCON structure, and even adding 0.5 wt % B₂O₃ [symbol] 0.5 wt %, no second phase or impurities are formed.

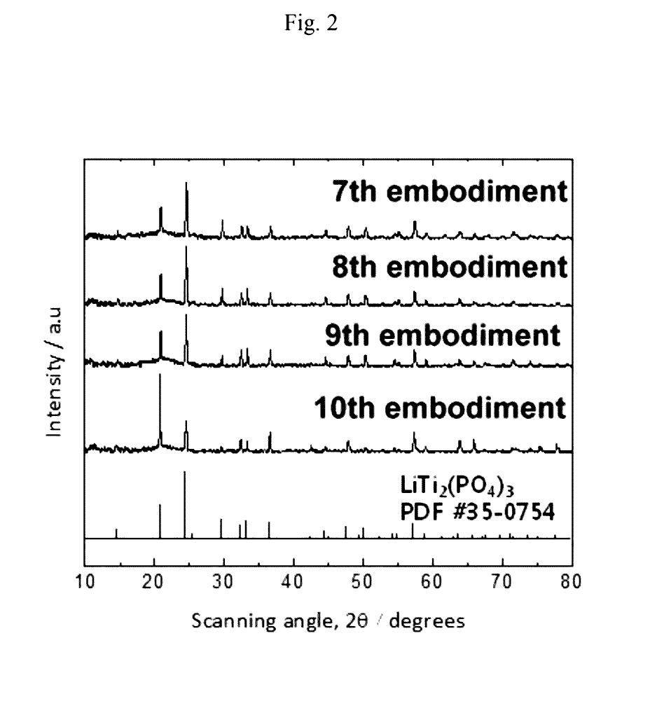

An X-ray diffraction experiment was conducted to grasp the crystalline structure of the solid electrolytes obtained according to the seventh to tenth embodiments of the present disclosure. A result of the test is shown in FIG. 2. As evident from FIG. 2, the solid electrolytes have substantially the same peak diffraction as LiTi₂(PO₄)₃ with a NAISCON structure, and even adding 0.5 wt % Bi₂O₃ no second phase or impurities are formed.

### Assessment Example 2: Scanning Electron Microscope (SEM) Experiment

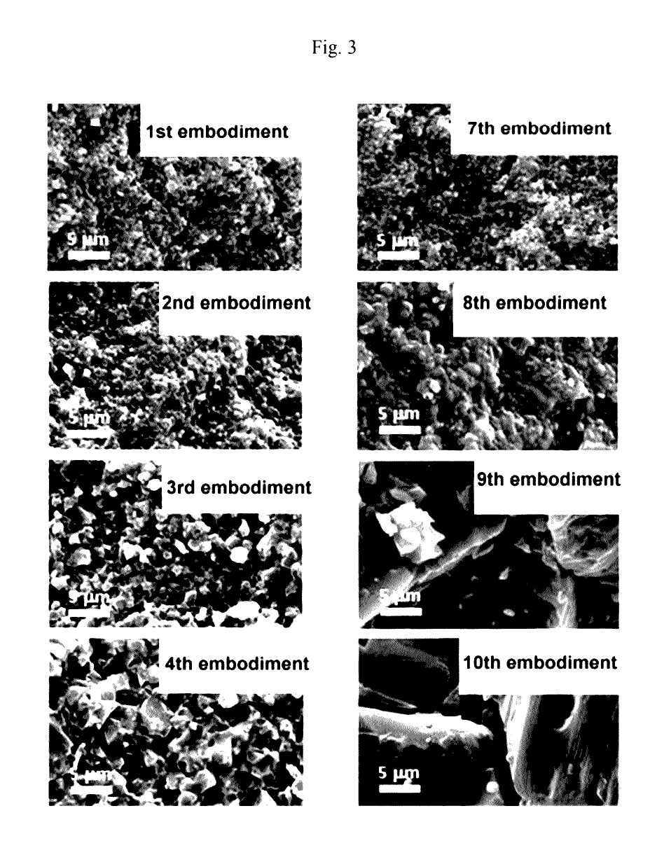

A scanning electron microscope (SEM) experiment was conducted to grasp the shape of cross sections of the solid electrolyte sintered bodies obtained according to the first, second, third, fourth, seventh, eighth, ninth, and tenth embodiments of the present disclosure. A result of the test is shown in FIG. 3. As evident from FIG. 3, in the case of the first, second, third, and fourth embodiments where B₂O₃ is added, as the sintering temperature increases, the particle size is gradually increased. In the case of the seventh, eighth, ninth, and tenth embodiments where Bi₂O₃ is added, an abnormal growth of particles at 900° C. or more may be observed.

### Assessment Example 3: Experiment for Measuring Relative Density of Sintered Body

The relative density of solid electrolytes obtained according to the first to twelfth embodiments and comparison examples 1 to 4 was measured. The sintered bodies were dried in a constant-temperature container at 110° C. for one hour, and the weight (W1) of the sintered bodies was then measured. The sintered bodies were boiled in ethanol for three hours, and ethanol was then removed from the surface of the sintered bodies. Then, the weight (W2) of the ethanol-removed sintered bodies and the weight (W3) of the sintered body in the ethanol were measured. The density was calculated through the following equation using Archimedes' principle:

Density=(W1×ρ)/(W2−W3)(ρ=density of ethanol)

The relative densities (%) of the sintered bodies were obtained by dividing the density by known theoretical densities. The relative densities are shown in Table 1 below:

TABLE 1

| Sintering | | | | | | |
|---|---|---|---|---|---|---|
| temperatures | 800° C. | 850° C. | 900° C. | 950° C. | | |
| Items (-) | Comparison | Comparison | Comparison | Comparison | | |
| | example 1 | example 2 | example 3 | example 4 | | |
| Relative | 78.0 | 79.8 | 81.6 | 89.6 | | |
| density (%) | | | | | | |
| Ionic | l.4 × 10⁻⁴ | 3.8 × 10⁻⁴ | 4.3 × 10⁻⁴ | 6.5 × 10⁻⁴ | | |
| conductance | | | | | | |
| (S cm⁻¹) | | | | | | |
| Items | First | Fifth | Second | Sixth | Third | Fourth |
| (B₂O₃ | embodiment | embodiment | embodiment | embodiment | embodiment | embodiment |
| added) | (0.5 wt %) | (0.2 wt %) | (0.5 wt %) | (1.0 wt %) | (0.5 wt %) | (0.5 wt %) |
| Relative | 80.4 | 87.9 | 81.8 | 87.3 | 82.1 | 91.2 |
| density (%) | | | | | | |
| Ionic | 1.8 × 10⁻⁴ | 3.3 × 10⁻⁴ | 6.7 × 10⁻⁴ | 6.5 × 10⁻⁴ | 8.6 × 10⁻⁴ | 1.4 × 10⁻³ |
| conductance | | | | | | |
| (S cm⁻¹) | | | | | | |
| Items | Seventh | Eleventh | Eighth | Twelfth | Ninth | Tenth |
| (Bi₂O₃ | embodiment | embodiment | embodiment | embodiment | embodiment | embodiment |
| added) | (0.5 wt %) | (0.2 wt %) | (0.5 wt %) | (1.0 wt %) | (0.5 wt %) | 0.5 wt %) |
| Relative | 93.0 | 96.3 | 90.0 | 99.7 | 96.3 | 99.3 |
| density (%) | | | | | | |
| Ionic | 1.6 × 10⁻⁴ | 7.9 × 10⁻⁴ | 8.8 × 10⁻⁴ | 9.9 × 10⁻⁴ | 4.3 × 10⁻⁴ | 3.3 × 10⁻⁵ |
| conductance | | | | | | |
| (S cm⁻¹) | | | | | | |

As compared with comparison examples 1, 2, 3, and 4 where neither B₂O₃ nor Bi₂O₃ was added, in the first to sixth embodiments and the seventh to twelfth embodiments where B₂O₃ and Bi₂O₃ were added at substantially the same sintering temperature, it can be seen that the relative density was increased, and thus, it can be verified that B₂O₃ and Bi₂O₃ functioned to increase the sintering density of the solid electrolyte.

### Assessment Example 4: Impedance Measurement Experiment and Calculation of Ionic Conductance Using the Same

An alternating current (AC) impedance measurement method was used to measure the ionic conductance of the solid electrolyte. Two opposite surfaces of the solid electrolyte were polished and coated with Au by sputtering, thus forming blocking interfacial surfaces which ions cannon pass through. An AC voltage having an amplitude of 5 mV and a frequency range of 700 kHz to 0.1 Hz was applied to the two opposite surfaces of the sintered body. A fitting method was used to measure the resistances at the points where the semi-circles of the impedance trajectories meet the real axis from the impedance shapes obtained, and the thickness and area of the samples were put in the following equation to calculate the overall ionic conductance through grain boundaries and in particles (bulk) of the solid electrolyte;

σ(S cm⁻¹)=1/(R)*(L/A)

where R is the resistance obtained from the fitting method, A is the area of the sintered body, and L is the thickness of the sintered body.

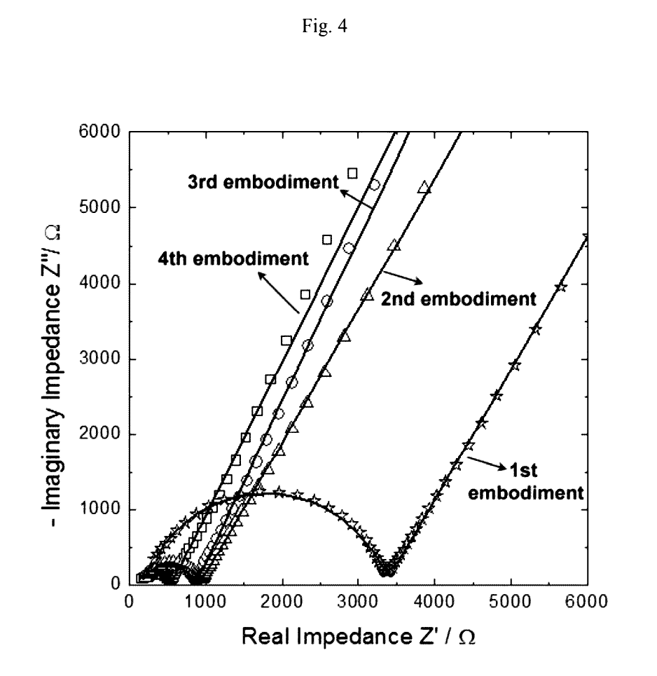

The shapes of impedances obtained according to the first to fourth embodiments are shown in FIG. 4. Table 1 shows the ionic conductance of the solid electrolytes obtained according to comparison examples 1 to 4 and the fifth to twelfth embodiments as measured in substantially the same method.

It can be verified that according to comparison examples 1 to 4, as the sintering temperature increases from 800° C. to 950° C., the relative density increases and the ionic conductance also increases from 1.4×10⁻⁴ S cm⁻¹ to 6.5×10⁻⁴ S cm⁻¹. In comparison with comparison examples 1 to 4, in the first to sixth embodiments where B₂O₃ is added, it can be verified that the relative density and the ionic conductance are increased, and thus, it can be verified that B₂O₃ increases the ionic conductance of the solid electrolyte by increasing the sintering density and reducing the grain boundary resistance. According to the fourth embodiment, a good ionic conductance at room temperature, e.g., an ionic conductance of 1.4×10⁻³ S cm⁻¹ at room temperature, may be obtained. According to the second embodiment, a similar ionic conductance to that according to the fourth embodiment may be obtained. Thus, the sintering temperature may be reduced by about 100° C.

In comparison with comparison examples 1 to 4, when Bi₂O₃ is added, it can be shown that the relative density may be increased, but the ionic conductance may be increased at the sintering temperature of 800° C. or 850° C. According to the twelfth embodiment, an ionic conductance of 9.9×10⁻⁴ S cm⁻¹ may be obtained, thus leading to an increased ionic conductance and the sintering temperature reduced by 100° C. as compared with comparison example 4. For example, Bi₂O₃ may be used as a sintering agent at a temperature not more than 900° C.

According to the ninth embodiment, no enhancement in ionic conductance was observed, and according to the tenth embodiment, the ionic conductance was rather reduced as compared with comparison examples 3 and 4. In the case where Bi₂O₃ is added as a sintering aid, if the sintering temperature is 900° C. or more, e.g., particle coarsening may be increased as shown in FIG. 2, and the ionic conductance may be thus reduced. Accordingly, when BiO₂O₃ is added as a sintering aid, adjusting the sintering temperature to less than 900° C. may lead to an increased the ionic conductance as compared with that obtained according to comparison examples 3 and 4.

According to embodiments of the present disclosure, substances such as B₂O₃ or Bi₂O₃ are added as sintering additives or sintering adis to an oxide-based lithium ion conducting solid electrolyte to reduce the sintering temperature and grain boundary resistance while increasing the density of sintered body, thereby increasing the lithium ionic conductance. Thus, higher-performance and high-output lithium batteries may be possible.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A solid electrolyte for a lithium battery, the solid electrolyte comprising:
an oxide represented in the following chemical formula; and
a sintering aid including B₂O₃ or Bi₂O₃, wherein the chemical formula is Li_{1+X}A_{X}B_{2-X}(PO₄)₃, wherein A is one or more substances selected from the group consisting of aluminum (Al), chrome (Cr), gallium (Ga), iron (Fe), scandium (Sc), indium (In), ruthenium (Ru), yttrium (Y), and lanthanum (La), B is one or more substances selected from the group consisting of titanium (Ti), germanium (Ge), and zirconium (Zr), and X has a value from 0.1 to 0.5.

2. The solid electrolyte of claim 1, wherein the content of the sintering aid is 0.1 to 3.0 parts by weight relative to 100 parts by weight of the solid electrolyte.

3. The solid electrolyte of claim 1, wherein the solid electrolyte further includes a substance selected from the group consisting of LLZO (Li₇La₃Zr₂O₁₂), LLTO (Li₃ₓLa_{2/3-x}TiO₃, 0<x<⅔), and LiPON (Li_{3-y}PO₄₋ₓNₓ, 0<y<3, 0<x<4).

4. The solid electrolyte of claim 1, wherein an ionic conductance of the solid electrolyte is not less than a value from 5.0×10⁻⁵ S/cm to 3.0×10⁻³ S/cm.

5. A method for preparing a solid electrolyte, the method comprising:
reacting a chelating agent with a first metal precursor including a Li precursor, a second metal precursor including a precursor of a metal selected from the group consisting of Al, Cr, Ga, Fe, Sc, In, Ru, Y, and La, a third metal precursor including a precursor of a metal selected from the group consisting of Ti, Ge, and Zr, and a P precursor to form a sol;
forming a gel by heating the sol;
pyrolizing the gel;
thermal-treating the pyrolized gel while bringing the gel in contact with the air to form a powder;
cooling the powder;
mixing the cooled powder with a sintering aid; and
press-forming the mixed powder and sintering the mixed powder while bringing the mixed powder in contact with the air.

6. The method of claim 5, wherein the Li precursor includes one or more substances selected from the group consisting of LiNO₃, Li₂CO₃, Li₂SO₄, and LiCl.

7. The method of claim 5, wherein the Al precursor includes one or more substances selected from the group consisting of a nitrogen compound, a sulfur compound, and a chlorine compound.

8. The method of claim 5, wherein the Ti precursor includes one or more substances selected from the group consisting of Ti(OCH₂CH₂CH₂CH₃)₄, and Ti[OCH(CH₃)₂]₄.

9. The method of claim 5, wherein the Ge precursor includes one or more substances selected from the group consisting of germanium dioxide (GeO₂), germanium tetrachloride (GeCl₄), germanium ethoxide (Ge(OC₂H₅)₄), germanium isopropoxide (Ge[OCH(CH₃)₂]₄), and germanium methoxide (Ge(OCH₃)₄).

10. The method of claim 5, wherein the Zr precursor includes one or more substances selected from the group consisting of zirconium oxide (ZrO₂), zirconium chloride (ZrCl₄), zirconium oxynitrate (ZrO(NO₃)₂), zirconium propoxide (ZrO(CH₂CH₂CH₃)₄), zirconium butoxide (Zr(OC₄H₉)₄), zirconium isopropoxide (Zr[OCH(CH₃)₂]₄), and zirconium tert-butoxide (Zr[OC(CH₃)₃]₄).

11. The method of claim 5, wherein the P precursor includes one or more substances selected from the group consisting of NH₄H₂PO₄, and H₃PO₄.

12. The method of claim 5, wherein the chelating agent includes citric acid or acetic acid.

13. The method of claim 5, wherein the amount of the chelating agent corresponds to about two to six times a sum of mole numbers of the first metal precursor, the second metal precursor, the third metal precursor, and the P precursor.

14. The method of claim 5, wherein the sol is heated at about 120° C. to about 200° C.

15. The method of claim 5, wherein the gel is heated at about 250° C. to about 350° C.

16. The method of claim 5, wherein the pyrolized gel is heated at about 700° C. to about 850° C.

17. The method of claim 5, wherein the amount of the sintering aid is about 0.1 weight % to about 3.0 weight % relative to the total amount of the powder and the sintering aid.

18. The method of claim 5, wherein the sintering aid includes one or more substances selected from the group consisting of B₂O₃ or Bi₂O₃.

19. The method of claim 18, wherein when the sintering aid is B₂O₃, the sintering temperature is about 750° C. to about 1000° C., and when the sintering aid is Bi₂O₃, the sintering temperature is about 750° C. to about 850° C.

20. A lithium battery, comprising:
a cathode including a cathode active material;
an anode including an anode active material;
a separator;
an electrolyte solution; and
a solid electrolyte, the solid electrolyte comprising:
an oxide represented in the following chemical formula; and
a sintering aid including B₂O₃ or Bi₂O₃, wherein the chemical formula is Li_{1+X}A_{X}B_{2-X}(PO₄)₃, wherein A is one or more substances selected from the group consisting of aluminum (Al), chrome (Cr), gallium (Ga), iron (Fe), scandium (Sc), indium (In), ruthenium (Ru), yttrium (Y), and lanthanum (La), B is one or more substances selected from the group consisting of titanium (Ti), germanium (Ge), and zirconium (Zr), and X has a value from 0.1 to 0.5.
